(19) United States
(12) Patent Application Publication
(10) Pub. No.: US 2013/0232832 A1
(43) Pub. Date: Sep. 12, 2013

(54) DISPLAY DEVICE, SYSTEM FOR CREATING A DISPLAY, AND PROCESS OF CREATING A DISPLAY

(71) Applicant: Frederic Frank OPSOMER, Kortemark (BE)

(72) Inventor: Frederic Frank OPSOMER, Kortemark (BE)

(73) Assignee: TAIT TECHNOLOGIES, INC., Waardamme (BE)

(21) Appl. No.: 13/543,272

(22) Filed: Jul. 6, 2012

(30) Foreign Application Priority Data
Mar. 8, 2012 (BE) 2012/0154

(51) Int. Cl. G09F 13/00

(52) U.S. Cl. 40/541

(57) ABSTRACT

Disclosed is a display device, a system for creating a display, and a process of creating a display. The process includes providing image data to a first spectator display device, the first spectator display device including one or more light emitting elements, providing image data to a second spectator display device, and activating at least one of the one or more light emitting elements based upon the image data. The first spectator display device is positioned within a spectator region of a venue and creates a display having an illusion of a continuous image.

### FIELD OF THE INVENTION

The present invention is directed to display devices, display systems, and display processes. More specifically, the present invention is directed to a light emitting devices, systems, and display processes.

### BACKGROUND OF THE INVENTION

It is well known that an illusion of larger image can be created by aligning a plurality of cards, such as is done in the formation of a mosaic. This concept has been employed in stadiums to produce images within a spectator portion of the stadium. For example, in one known display of these cards, each card was a rigid flat panel including a printed image that is a portion of a larger image to be assembled. The spectators received assigned cards corresponding to their seats in the stadium. Such printed displays have substantial limitations with regard to brightness or resolution. Furthermore, such printed displays are not capable of displaying sequences of moving images, and cannot be used quickly to display real-time data.

Known electronic display screens have been used in stadiums for display of enlarged digital images, particularly for advertising on billboards and similar structures. These electronic display screens suffer from the drawback of requiring externally supplied central power and/or consolidated control. Also, these electronic display screens are not part of a system designed for independently controlled spectator-mounted electronic display devices that encourage spectator interaction and participation.

A display device, a system for creating a display, and a process of creating a display, that do not suffer from one or more of the above drawbacks would be desirable in the art.

### BRIEF DESCRIPTION OF THE INVENTION

In an exemplary embodiment, a process of creating a display having an illusion of a continuous image includes providing image data to a first spectator display device, the first spectator display device including one or more light emitting elements, providing image data to a second spectator display device, and activating at least one of the one or more light emitting elements based upon the image data. The first spectator display device is positioned within a spectator region of a venue.

In another exemplary embodiment, a system for creating a display having an illusion of a continuous image includes a first spectator display device including one or more light emitting elements, a second spectator display device, and a controller capable of providing image data to one or both of the first spectator display device and the second spectator display device. At least one of the one or more light emitting elements is capable of being activated based upon the image data. At least a portion of the first spectator display device is positioned within a spectator region of a venue.

In another exemplary embodiment, a spectator display device for creating a display in a venue includes one or more light emitting elements capable of being activated upon receiving image data. The spectator display device is positioned within a spectator region of the venue and the image data corresponds with a portion of the display.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an exemplary display at a venue according to the disclosure.

FIG. 2 is an enlarged perspective view of an exemplary display in a spectator region showing spectator positions according to the disclosure.

FIG. 3 is an enlarged cutaway perspective view of an exemplary seat-mounted display according to the disclosure.

FIG. 4 is an enlarged cutaway front view of an exemplary spectator-mounted display according to the disclosure.

FIG. 5 is a perspective front view of an exemplary spectator display device according to the disclosure.

FIG. 6 is a perspective rear view of an exemplary spectator display device according to the disclosure.

FIG. 7 is a schematic of an exemplary display system according to the disclosure.

Wherever possible, the same reference numbers will be used throughout the drawings to represent the same parts.

### DETAILED DESCRIPTION OF THE INVENTION

Provided is a display device, a system for creating a display, and a process of creating a display. Embodiments of the present disclosure create an illusion of a continuous image, create an illusion of three-dimensional objects or images, provide a higher quality graphic display with the desired level of brightness and resolution of an enlarged digital image, permit still or moving images to be displayed as an array within a spectator region of a venue, encourage spectator participation in creating an arrayed display, and permit display of complex image sequences through independent control of hand-held electronic display devices, or combinations thereof.

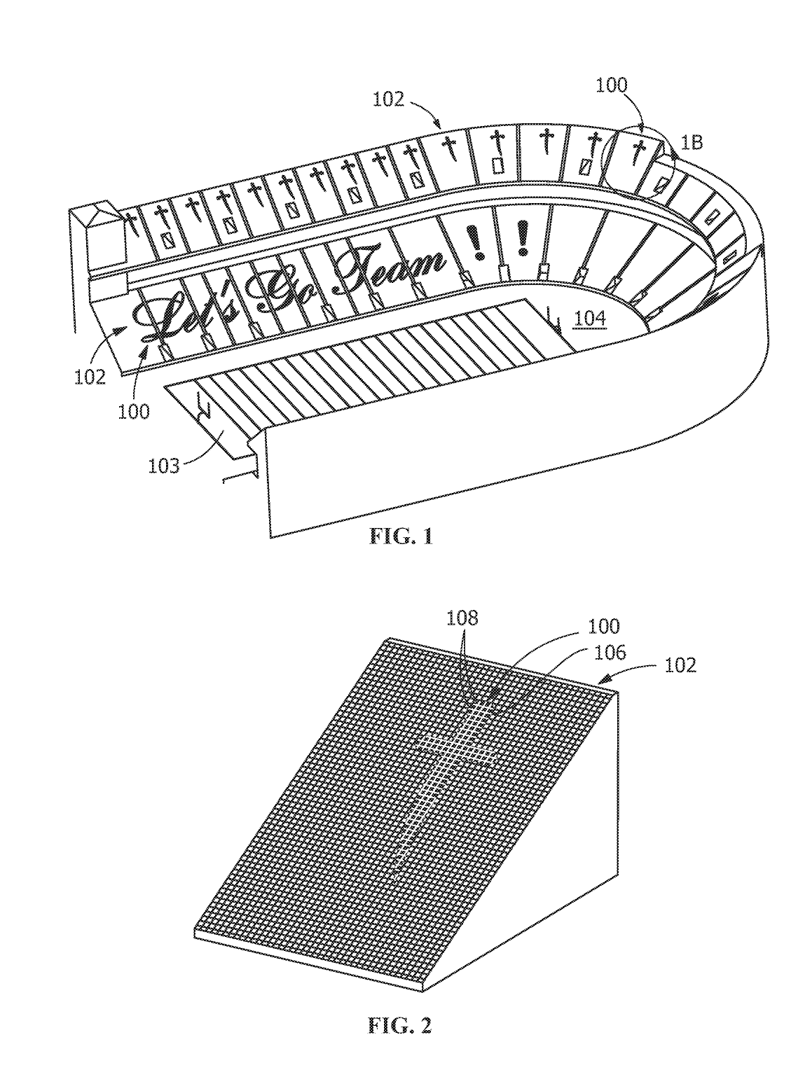

Referring to FIGS. 1 and 2, in one embodiment, a display 100 within a spectator region 102 of a venue 104 is shown. The display 100 includes a plurality of spectator display devices 106 arranged and disposed within the spectator region 102. In another embodiment, the display 100 includes a plurality of spectator display devices 106 arranged and disposed within a non-spectator region 103. The non-spectator region 103 includes any suitable non-spectator region, such as, a playing field, performance stage, dugouts or other player area, band or orchestra area, media/announcer area, concessions, ticket or merchandizing area, or parking lots, for example. In one embodiment, display coordinates corresponding to a row and seat number for one or more individual spectator positions 108, such as 8A, 8B, 8C, 9A, 9B, 9C, for example, create a 2 dimensional array map. An example of such display coordinates that are used to create an image 100 include display coordinates corresponding to seat numbers 18CC, 19BB, 19CC, 20BB, 20CC, 21AA, 21BB, 22AA, 22BB, 23AA, 23BB, 24Z, 24AA, 24BB, 25Z, 25AA, 25BB, 26Y, 26Z, 26AA, 27Y, 27Z, 27AA, 28Y, 28Z, 28AA, 29X, 29Y, 29Z, 29AA, 30X, 30Y, 30Z, 30AA, 31W, 31X, 31Y, 31Z, 32W, 32X, 32Y, 32Z, 33V, 33W, 33X, 33Y, 33Z, 34V, 34W, 34X, 34Y, 34Z, 35U, 35V, 35W, 35X, 35Y, 36U, 36V, 36W, 36X, 36Y, 37U, 37V, 37W, 37X, 37Y, 37T, 38U, 38V, 38W, 38X, 39T, 39U, 39V, 39W, 39X, 40T, 40U, 40V, 40W, 40X, 41T, 41U, 41V, 41W, 41X, 42T, 42U, 42V, 42W, 42X, 43T, 43U, 43V, 43W, 43X, 44T, 44U, 44V, 44W, 44X, 45T, 45U, 45V, 45W, 45X, 46O, 46P, 46Q, 46R, 46S, 46T, 46U, 46V, 46W, 46X, 46Y, 46Z, 46AA, 46BB, 46CC, 47O, 47P, 47Q, 47R, 47S, 47T, 47U, 47V, 47W, 47X, 47Y, 47Z, 47AA, 47BB, 47CC, 48O, 48P, 48Q, 48R, 48S, 48T, 48U, 48V, 48W, 48X, 48Y, 48Z, 48AA, 48BB, 48CC, 49O, 49P, 49Q, 49R, 49S, 49T, 49U, 49V, 49W, 49X, 49Y, 49Z, 49AA, 49BB, 49CC, 50T, 50U, 50V, 50W, 50X, 51T, 51U, 51V, 51W, 51X, 52T, 52U, 52V, 52W, 52X, 53T, 53U, 53V, 53W, 53X, 54T, 54U, 54V, 54W, 54X, 55T, 55U, 55V, 55W, 55X, 56T, 56U, 56V, 56W, 56X, 57S, 57T, 57U, 57V, 57W, 57X, 58S, 58T, 59U, 59V, 59W, 59X, 59S, 59T, 59U, 59V, 59W, 59X, and 60U, 60V.

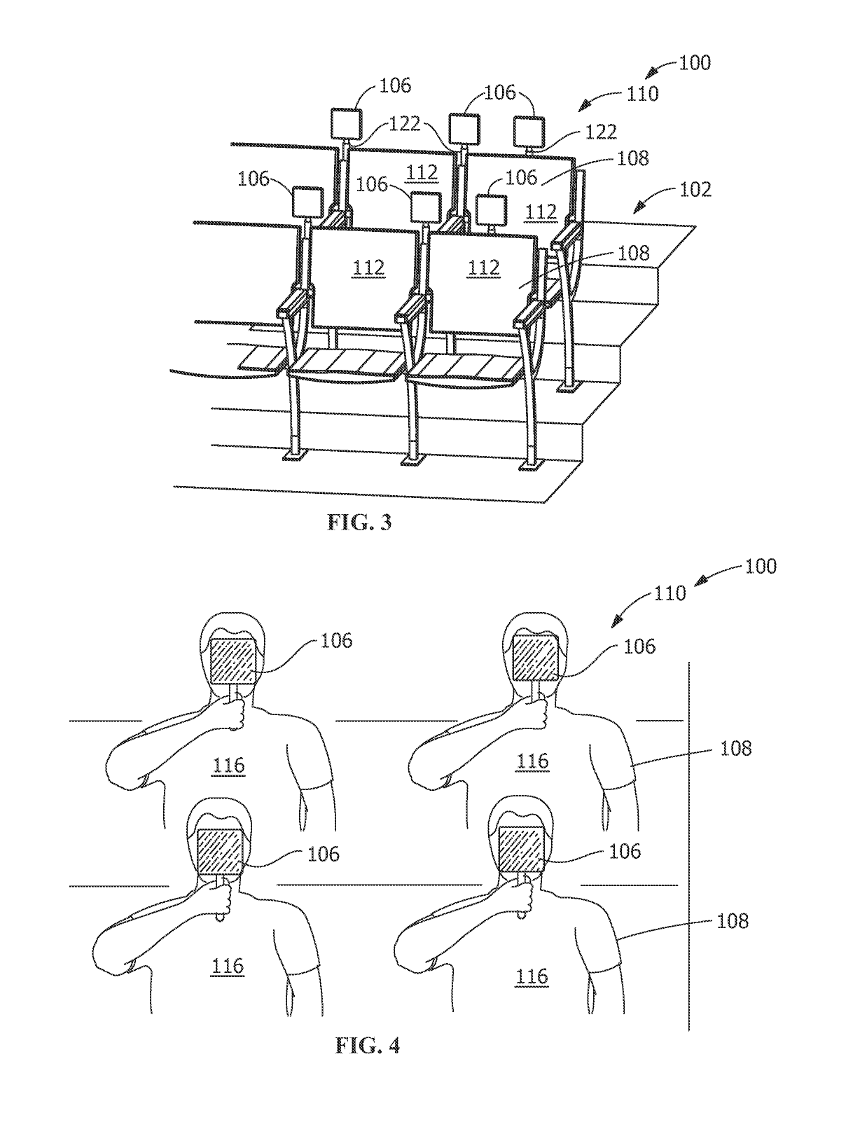

In one embodiment, at least a portion of the spectator positions 108 includes one or more of the spectator display devices 106 (see FIGS. 3 and 4). In one embodiment, each spectator display device 106 is electronically assigned the corresponding spectator position 108 display coordinates within the array map. In one embodiment, a tracking system is used to electronically tag and track the position of the spectator display devices 106. Such tracking system includes suitable positioning and tracking equipment, components or devices such as RFID (radio-frequency identification), Wi-Fi radios, networked wireless detectors, tracking algorithms, GPS (global positioning system), AGPS (assisted global positioning system), or other local positioning systems, for example. In one embodiment, the tracking system is configured for feedback capabilities that detect irregular positions and modify the image data transmitted. For example, the tracking system detects if an assigned spectator display device is not positioned in the corresponding spectator position, if a spectator position no longer had a spectator display device, or if the spectator display device had ceased functioning. Further, the tracking system reprocesses and adjusts the image data to be transmitted in order to maintain the desired display image in spite of the irregularities. In one embodiment, if the assigned spectator display device is positioned slightly off from the position desired relative to the corresponding spectator position, the tracking system reprocesses and adjusts the image data to be transmitted to that spectator display device in order to maintain the desired display image. In one embodiment, at least a portion of the plurality of the spectator display devices 106 is positioned within the spectator region 102.

A spectator region 102 is located in any suitable venue 104 and is an area capable of arranging people in a configuration desirable for viewing an event, such as a sporting or entertainment event. Examples include a sports stadium, concert, or other performance. The spectator region 102 is located in any suitable environment, such as outdoors, exposed to ambient conditions, indoors, underwater, or partially exposed, for example, or combinations thereof. In one embodiment, the individual spectator positions 108 are arranged and disposed within the spectator region 102 with the rows or seating positioned in any suitable arrangement, such as multi-level, staggered, tiered, curved, or single-level, for example, or combinations thereof.

In one embodiment, the display 100 has the illusion of a continuous image when viewed from a suitable distance within on beyond the venue 104. In one embodiment, the display 100 represents suitable three-dimensional objects or images, or landscapes, for example. In one embodiment, the image graphic represents text, or forms a text string creating a message. In one embodiment, the display 100 includes a seat-mounted display 110 (see FIG. 3) or a spectator-mounted display 114 (see FIG. 4), or combinations thereof.

Referring to FIG. 3, in one embodiment, the seat-mounted display 110 including a plurality of the spectator display devices 106 is shown. The seat-mounted display 110 includes the display devices 106 arranged and disposed on or adjacent to a seat 112 within the spectator region 102. Individual seats 112 correspond with the spectator position 108 display coordinates within the array map. In one embodiment, the seat 112 includes a fastening device 122, such as a mounting sleeve or clamp, for example, to removably secure the spectator display device 106. In one embodiment, the spectator display devices 106 are arranged and disposed to be spaced apart some predetermined distance from adjacent display devices. In one embodiment, the predetermined spacing includes three suitable parameters, such as x, y, and z, for example, corresponding to x as horizontal side-by-side distance, y as horizontal front-to-back distance, and z as vertical distance. In one embodiment, the predetermined spacing is from about 20 inches to about 4 feet, from about 20 inches to about 3 feet, from about 20 inches to about 30 inches, from about 2 feet to about 3 feet, from about 3 feet to about 4 feet, or any suitable range therein. In one embodiment, the predetermined spacing distance of the adjacent display devices is approximately the same distance as the center-to-center spacing of the adjacent seats 112 that the corresponding spectator display devices 106 are disposed on or adjacent to. In another embodiment, the predetermined spacing distance of the adjacent display devices is a different distance from the center-to-center spacing of the adjacent seats 112 that the corresponding spectator display devices 106 are disposed on or adjacent to.

Referring to FIG. 4, in one embodiment, the spectator-mounted display 114 including a plurality of the spectator display devices 106 is shown. The spectator-mounted display 114 includes the spectator display devices 106 arranged and disposed on or by a spectator 116 within the spectator region 102. In one embodiment, the predetermined spacing distance of the adjacent display devices is approximately the same distance as the center-to-center spacing of the adjacent seats 112 assigned to the spectator 116 that the corresponding spectator display devices 106 are disposed on or by. In another embodiment, the predetermined spacing distance of the adjacent display devices is a different distance from the center-to-center spacing of the adjacent seats 112 that the corresponding spectator display devices 106 are disposed on or by. In one embodiment, the spectator-mounted display 114 is formed by the spectator 116 holding the spectator display device 106 in a suitable viewable position, such as in front of their face, facing toward the center of the venue 104, for example. In one embodiment, the spectator-mounted display 114 is formed by the spectator 116 removably attaching or securing the spectator display device 106 to their person by suitable mounting, such as by headgear, or chest harness, for example, for a hands-free display. The spectator-mounted display 114 operates to encourage participation of the spectator 116 in the creation of performance art.

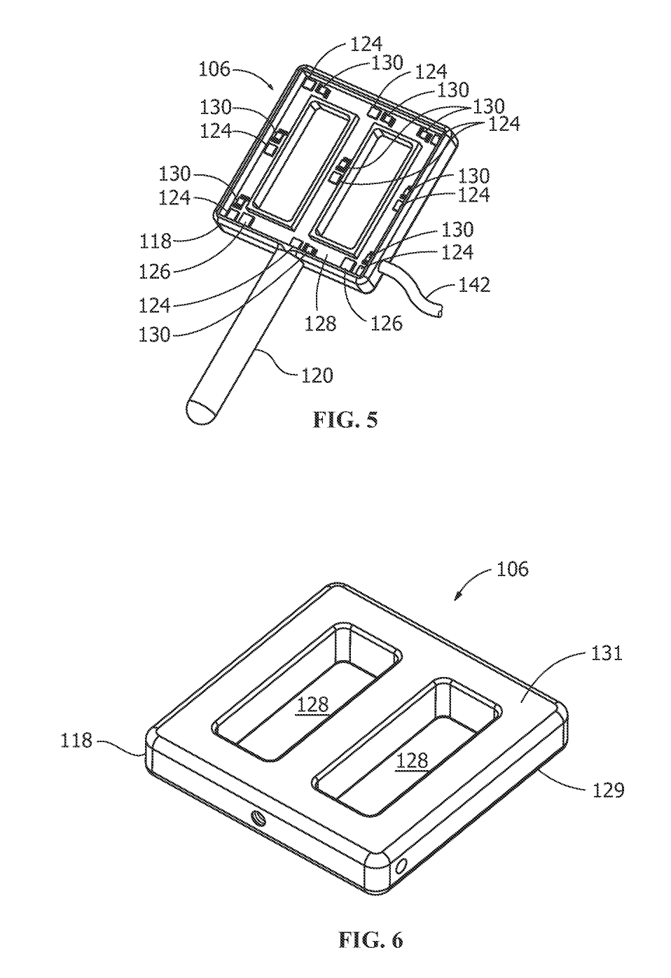

Referring to FIG. 5, in one embodiment, the spectator display device 106 for creating a display 100 in a venue 104 is shown. In one embodiment, the spectator display device 106 includes a display portion 118 and a handle 120 secured to or extending from the display portion 118. In one embodiment, the display portion 118 includes one or more of light emitting elements 124 connected to the display portion 118. In one embodiment, the display portion 118 includes a display controller 126 configured to control the light emitting elements 124. In one embodiment, the display controller 126 is an independently controlled addressable controller.

In one embodiment, the light emitting elements 124 include light emitting diodes (LEDs), for example, or any suitable light emitting elements such as video strips, organic light emitting diodes (OLEDs), fiber optic lights, fluorescent lights, incandescent lights, neon lights, polymer light emitting diodes, electroluminescent lights, or combinations thereof. In one embodiment, the light emitting elements 124 include a grouping of red, green and blue LEDs, although in other embodiments, different numbers and colors of emitting elements are used. The light emitting elements 124 are a single unitary construction capable of providing a range of colored light and/or a range of intensity of light or a combined construction capable of providing the range of colored light and/or the range of intensity of light. In one embodiment, the light emitting elements 124 are configured for a modular grouping connected to a suitable board, such as a pluggable printed circuit board, for example, and are capable of quick disconnection from the display portion 118 for changing in or out. In one embodiment, the display portion 118 includes nine of the light emitting elements 124 connected to the display portion 118 in a spaced arrangement. The number and positioning of the light emitting elements 124 is suitable to provide the desired visual, video or combined image effect.

In one embodiment, the display portion 118 includes a cover panel 128 configured to allow light transmission while providing protection to the light emitting elements 124. In one embodiment, the cover panel 128 is fabricated of a transparent polycarbonate with a scratch and UV resistant, antireflective coating, or any other suitable durable transparent or semi-transparent or semi-translucent material capable of supporting a predetermined structural load (as if sat or stepped upon, for example), and resisting cracking if dropped onto a concrete surface by a spectator 116. In one embodiment, the spectator display device 106 housing is fabricated of a durable, moldable polymeric material, or any other suitable durable material capable of supporting a predetermined structural load and resisting impact fractures. In one embodiment, the spectator display device 106 includes a suitable resilient or elastomeric material to provide improved gripping and/or shock absorption.

In one embodiment, the spectator display device 106 includes a element controller 130 configured for control of each individual light emitting element 124. In one embodiment, the spectator display device 106 includes or more light emitting elements 124 including independently controlled light emitting diodes. In one embodiment, the element controller 130 is an independently controlled addressable controller. In one embodiment, the display controller 126 controls one or more of the element controllers 130. The light emitting elements 124 are controlled by any suitable single controller or series of controllers, such as a microprocessor, for example, which coordinate display of images and/or video. In one embodiment, the element controllers 130 are programmable controllers.

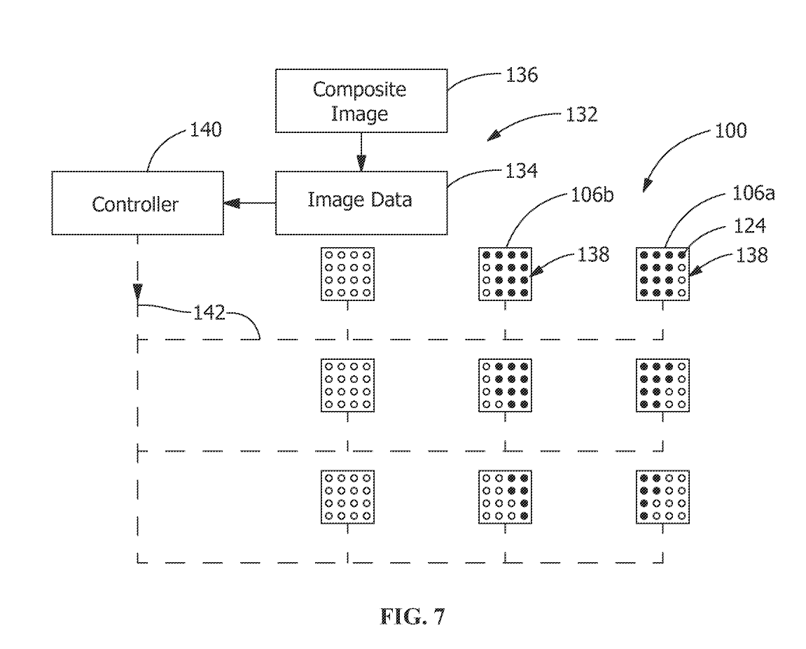

Referring to FIG. 6, in one embodiment, the display portion 118 includes a front side 129 and a rear side 131. In one embodiment, the rear side 131 is not configured to create a display 100. In one embodiment, the spectator display device 106 is configured to display an image on both the front side 129 and the rear side 131. In one embodiment, the spectator display device 106 is controlled to display different images on the front side 129 and the rear side 131.

Referring to FIG. 7, in one embodiment, a system 132 for creating a display 100, is shown. In one embodiment, the system 132 includes a plurality of spectator display devices 106 provided with image data 134. For example, as shown in FIG. 7, in one embodiment, the system 132 includes a first spectator display device 106a and a second spectator display device 106b. In one embodiment, at least a portion of the first spectator display device 106a is positioned within the spectator region 102 of the venue 104. In one embodiment, the spectator display device 106 is configured to receive image data 134, and at least one of the one or more light emitting elements 124 is capable of being activated based upon the image data 134. In one embodiment, the display controller 126 is preprogrammed with image data 134. In one embodiment, a composite image 136 is converted into the image data 134. In one embodiment, the image data 134 provided is real-time data from a live feed.

In one embodiment, the spectator display device 106 is configured to activate at least one of the one or more light emitting elements 124 based upon the image data 134 to display a pixel image 138 or a sequence of pixel images 138. In one embodiment, the spectator display device 106 is configured to display the pixel image 138 in real-time or substantially real-time from a live feed, for example, with little or no image data manipulation, such as by interpolation, morphing, and/or dissolving. In one embodiment, the spectator display devices 106 are driven by any suitable image, such as still image, live image, predefined video, animated image, or interactive image, for example. The plurality of spectator display devices 106 are arranged and disposed in the array map whereby the pixel images 138 produced are configured to form or create a substantially continuous display 100, providing an illusion of a continuous image.

In one embodiment, the image data 134 is communicated by a remote controller 140. In one embodiment, the remote controller 140 is capable of providing image data 134 to the spectator display devices 106. In one embodiment, the remote controller 140 independently controls the spectator display devices 106. In one embodiment, the control of spectator display devices 106 is provided by one or more controllers and includes any suitable programmable controller for coordinating video or image displays, such as a computer, computing device, or processor, for example, or combinations thereof. In one embodiment, the remote controller 140 is operated by a predetermined suitable operator, such a performer, a player, an announcer, a producer, or a designated spectator (i.e., a winner of a privileged operator lottery or contest), for example.

In one embodiment, the spectator display devices 106 are connected to each other and/or the remote controller 140 by any suitable connection, including, but not limited to, a wired connection 142, or other communication and/or power transmitting device. In one embodiment, the spectator display devices 106 control includes communication via a serial wired connection. In one embodiment, the spectator display devices 106 control includes communication via a wireless connection such as through an infrared (IR), radiofrequency (RF), other suitable wavelengths, or any other electromagnetic signal, for example. In one embodiment, the stream of image data 134 is transmitted to all the spectator display devices 106 to provide the desired visual display 100. The addressable capability of the display controller 126 allows the individual spectator display devices 106 to receive and process the specific image data 134 transmitted for that corresponding device. The system 132 utilizes suitable software, hardware, video signals, image signals, controllers, media servers, control devices and electronics, and combinations thereof to generate, transmit, and process video and/or images for display of the pixel images 138 through the spectator display devices 106.

In one embodiment, the spectator display devices 106 are powered from a local power source, such as one or more batteries arranged and disposed therein. In one embodiment, the spectator display devices 106 are powered by an external power source provided by a power cord, for example. In one embodiment, the external power is provided by power wiring run inside the same cable housing as the image data communication wiring. In one embodiment, the wired connection 142 includes power and/or signal capability. For example, the wired connection 142 includes one or more suitable electrical communication and/or power providing cables, such as fiber optic, coaxial cable, RCA cable, Ethernet cables, or copper-based wires or cables, or Ethernet cables. Referring again to FIG. 5, in one embodiment, the spectator display device 106 is configured to allow the signal/power connection to be attached on either side of or on multiple locations on the device.

In one embodiment, the activation based upon the image data 134 includes various control functions such as independently turning the display capability of the spectator display devices 106 on or off, for example. In one embodiment, the activation further includes independently controlling a level of intensity of the light emitting elements 124 to vary the brightness of light displayed, and/or independently controlling the light emitting elements 124 to vary the color displayed by each of the light emitting elements. In another embodiment, the light emitting elements 124 emit multiple colors of light simultaneously or at different times. In one embodiment, the activation includes various control sequences of operation such as independently controlling the light emitting elements 124 to vary the duration and sequences of light displayed, for example. In one embodiment, activation includes controlling all of the one or more light emitting elements 124 simultaneously. In one embodiment, activation includes controlling only a portion of the one or more light emitting elements 124. In another embodiment, activation includes any combination of the above controls, or control of any suitable other features and properties of the spectator display device 106 affecting the formation of the pixel image 138. In one embodiment, for example, the pixel image 138 is controlled to include the upper third of the light emitting elements 124 emitting red light at 50 percent intensity while the remaining light emitting elements 124 emit white light at 100 percent intensity, both simultaneously, for a duration of one minute. In one embodiment, the range of light intensity simultaneously displayed on one spectator display devices 106 is from about 30 percent to about 100 percent, from about 30 percent to about 50 percent, or from about 60 percent to about 80 percent, or any suitable range therein.

In one embodiment, the composite image 136 is converted into the image data 134 through use of an interpolation rendering algorithm. In this embodiment, the composite image 136 (a three dimensional model in a vector graphics format, for example), is converted into a raster image of pixels in a two dimensional plane for output or for storage. In one embodiment, the rendering algorithm includes a perspective projection transformation utilizing a regenerated frustum as the intermediated form factor. In one embodiment, the interpolation rendering algorithm includes an interpolation scaling algorithm. The scaling algorithm is utilized to enlarge or scale up the image to create the display 100 in the desired venue 104, such as in a sports stadium, or concert, for example.

In one embodiment, a process of creating a display 100 having an illusion of a continuous image includes providing image data 134 to a plurality of spectator display devices 106. For example, as shown in FIG. 7, in one embodiment, the process includes providing image data 134 to a first spectator display device 106a, the first spectator display device 106a having one or more light emitting elements 124, and providing image data 134 to a second spectator display device 106b. The process includes activating at least one of the one or more light emitting elements 124 based upon the image data 134. In one embodiment, the process includes converting the composite image 136 into the image data 134. In one embodiment, the process includes the spectator display devices 106 positioned within a spectator region of a venue 104 (see FIG. 1).

In one embodiment, the conversion of the composite image 136 into the image data 134 includes creating a fullscreen digital pixelated image having a plurality of digital pixels. In one embodiment, each digital pixel includes digital pixel image data. The digital pixel image data includes corresponding electronic properties such as position coordinates in a digital array grid, a predetermined color, and a predetermined intensity, for example. In one embodiment, the process further includes assigning all or a portion of the digital pixel image data to corresponding all or a portion of the corresponding spectator position 108 display coordinates within the array map of the venue 104. In one embodiment, the image data 134 corresponds with a portion of the display 100. In one embodiment, the process further includes wherein the image data 134 includes the digital pixel image data.

In one embodiment, the image data 134 used to form the pixel image 138 takes into account the predetermined viewing angle of display 100 with respect to a surface or object, such as a stage, a performer, or an overhead blimp, for example. In one embodiment, the conversion of the composite image 136 into the image data 134 includes utilizing the coordinates of a focal object at the venue, such as a stage performer, for example, as the focal point for determining one or more viewing angles for the pixel image 138.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process of creating a display having an illusion of a continuous image, the process comprising:
providing image data to a first spectator display device, the first spectator display device including one or more light emitting elements; and
providing image data to a second spectator display device; and
activating at least one of the one or more light emitting elements based upon the image data;
wherein the first spectator display device is positioned within a spectator region of a venue.

2. The process of claim 1, wherein the first spectator display device is independently controlled.

3. The process of claim 1, wherein the activating includes independently turning a display capability of the first spectator display device on or off.

4. The process of claim 1, wherein the activating includes independently controlling a level of intensity of the light emitting elements to vary the brightness of light displayed.

5. The process of claim 1, wherein the activating includes independently controlling the light emitting elements to vary the color displayed by each of the light emitting elements.

6. The process of claim 1, wherein the activating includes independently controlling the light emitting elements to vary the duration and sequence of light displayed.

7. The process of claim 1, wherein the activating includes controlling only a portion of the one or more light emitting elements.

8. The process of claim 1, wherein the activating includes controlling all of the one or more light emitting elements simultaneously.

9. The process of claim 1, wherein the light emitting elements include light emitting diodes.

10. The process of claim 1, wherein the image data is real-time data from a live feed.

11. The process of claim 1, wherein the light emitting elements are activated to display a pixel image or a sequence of pixel images.

12. The process of claim 1, wherein the first spectator display device is independently powered.

13. The process of claim 1, wherein the first spectator display device further includes a display controller preprogrammed with image data.

14. The process of claim 1, wherein the display uses the coordinates of a focal object at the venue as the focal point for determining one or more view angles for the pixel image.

15. The process of claim 1, wherein the process further includes creating digital pixel image data having corresponding electronic properties including position in a digital array grid, a predetermined color, and a predetermined intensity.

16. The process of claim 15, wherein the process further includes creating an array map having display coordinates corresponding to one or more individual spectator positions within the spectator region of the venue.

17. The process of claim 16, wherein the process further includes assigning all or a portion of the digital pixel image data to corresponding all or a portion of the display coordinates.

18. The process of claim 17, wherein the image data includes the digital pixel image data.

19. A system for creating a display having an illusion of a continuous image, the system comprising:
a first spectator display device, the first spectator display device including one or more light emitting elements;
a second spectator display device; and
a controller capable of providing image data to one or both of the first spectator display device and the second spectator display device;
wherein at least one of the one or more light emitting elements is capable of being activated based upon the image data; and
wherein at least a portion of the first spectator display device is positioned within a spectator region of a venue.

20. A spectator display device for creating a display in a venue, the spectator display device comprising:
one or more light emitting elements capable of being activated upon receiving image data;
wherein the spectator display device is positioned within a spectator region of the venue;
wherein the image data corresponds with a portion of the display.
